(19) United States
(12) Patent Application Publication
(10) Pub. No.: US 2026/0109018 A1
(43) Pub. Date: Apr. 23, 2026

(54) Tool Set Holder

(71) Applicant: Snap-on Incorporated, Kenosha, WI (US)

(72) Inventors: David D. Curry, Mt. Pleasant, WI (US); Daniel F. Marcus, Lake Villa, IL (US)

(73) Assignee: Snap-on Incorporated, Kenosha (omitted)

(21) Appl. No.: 19/360,490

(22) Filed: Oct. 16, 2025

Related U.S. Application Data
(60) Provisional application No. 63/710,019, filed on Oct. 21, 2024.

(51) Int. Cl. B25H 3/04

(52) U.S. Cl. CPC B25H 3/04

(57) ABSTRACT

A tool set holder including a base to receive a tool set insert containing one or more tools from a tool set. The tool set holder includes a bottom flange extending forward from a bottom edge of the base. The bottom flange is to support the tool set insert. The tool set holder includes a first side flange extending forward from a first side edge of the base and a second side flange extending forward from a second side edge of the base. The tool set holder receives the tool set insert between the first side flange and the second side flange. The tool set holder includes a posterior flange extending rearward from the base. The posterior flange is configured to attach the tool set holder to a vertical surface of a work center.

### CROSS-REFERENCE TO RELATED APPLICATION

This application claims the benefit of U.S. Provisional Application No. 63/710,019 entitled, “Tool Set Holder,” filed on October 21, 2024, the entire contents of which is hereby incorporated.

### BACKGROUND

A user may use tools for many different work projects. Tool holders or other tool receptacles hold tools from a tool set near a work center for a user to access the tool while working at the work center.

Some tool holders are designed for one specific type of tool and are shaped and sized to hold only one size of tool. Other tool holders may only vertically hold tools, which may impact a user’s ability to access the tools.

### SUMMARY

This disclosure relates to a tool set holder that attaches one or more tools in a tool set onto a vertical panel at and/or near a work center in order to display the one or more tools a user working at the work center. The tool set holder may improve the presentation of one or more tools in a tool set to a user, without using space on a work surface of the work center. The tool set holder may also allow a user to more easily identify tools in the tool set holder and remove the tools for use.

In one embodiment a tool set holder includes a base configured to receive a tool set insert containing one or more tools from a tool set. The tool set holder includes a bottom flange extending forward from a bottom edge of the base. The bottom flange supports the tool set insert. The tool set holder includes a first side flange extending forward from a first side edge of the base and a second side flange extending forward from a second side edge of the base. The tool set holder receives the tool set insert between the first side flange and the second side flange. The tool set holder includes a posterior flange extending rearward from the base. The posterior flange is to attach the tool set holder to a vertical surface of a work center.

In some embodiments, the tool set holder includes a posterior flange extending rearward from the base. The posterior flange is configured to attach the tool set holder to a vertical surface of a work center.

Other embodiments will become apparent to those of ordinary skill in the art by reading the following detailed description, with reference where appropriate to the accompanying drawings.

### BRIEF DESCRIPTION OF THE DRAWINGS

Example embodiments are described herein with reference to the drawings.

FIG. 1A is a perspective view of a tool set holder, according to an example embodiment.

FIG. 1B is an additional perspective view of the tool set holder of FIG. 1A.

FIG. 2 is a perspective view of a tool set holder, according to an example embodiment.

FIG. 3A is a depiction of a work center having a tool set holder, according to an example embodiment.

FIG. 3B is a further view of the tool set holder of FIG. 3A holding one or more tools.

FIG. 4 is a depiction of a work center having a plurality of tool set holders that each hold one or more tools, according to an example embodiment.

### DETAILED DESCRIPTION

This description describes several example embodiments, at least some of which pertain to tool set holders at and/or near a work center. Embodiments of the tool set holder attach one or more tools in a tool set to a vertical surface of a work center, such as a vertical wall, which may improve the visibility of and access to the one or more tools without taking up space on a work surface of the work center. With limited available space in a work center, it is beneficial to improve available workspace on a work surface of the work center while still having tools in a tool set within a user’s reach.

The tool set holder may be a single piece or a multiple piece design. In some embodiments, the tool set holder directly attaches to the vertical wall of the work center. In other embodiments, the tool set holder attaches to the vertical wall of the work center through a fastener. The tool set holder may enable a full set of tools in a tool set to be displayed to a user at a work center. As those of ordinary skill in the art will understand, vertical, as used in this application, refers to being in substantial alignment with the force of gravity in a downwards direction as opposed to in a sideways direction.

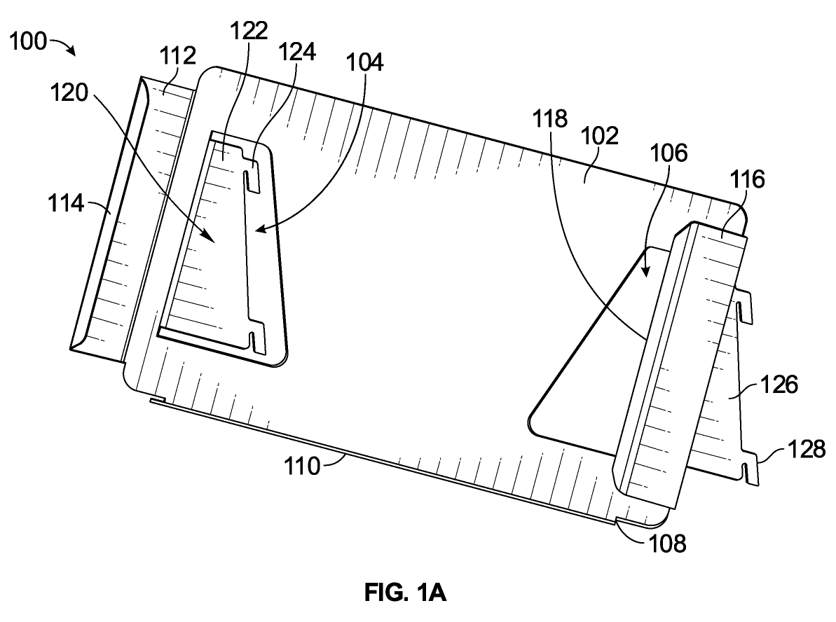

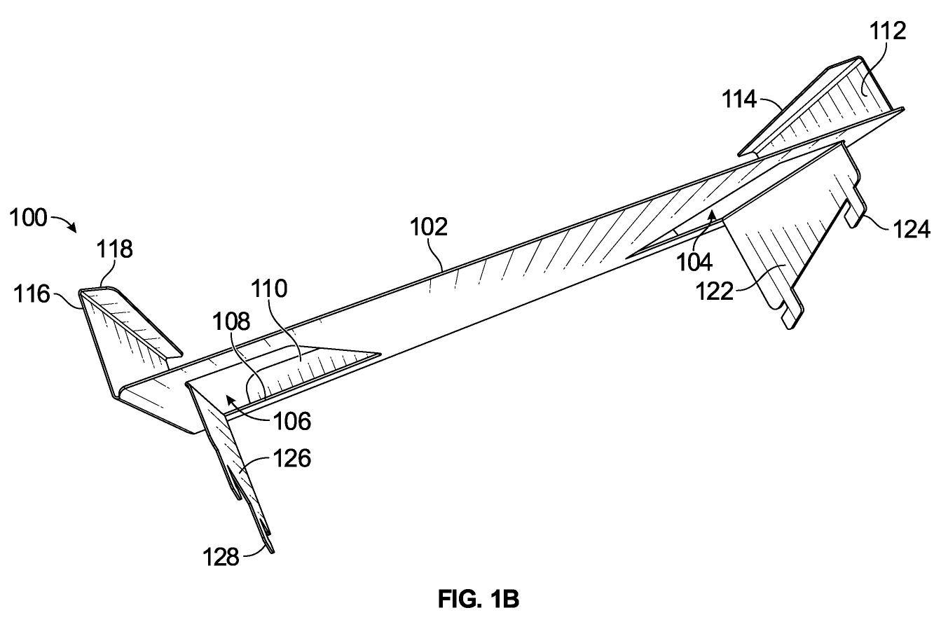

FIGS. 1A and 1B illustrate a tool set holder 100, according to an example embodiment. The tool set holder 100 is attachable to a vertical surface of a work center. In some embodiments, components of the tool set holder 100 comprise a strong material, such as a metal. The entire tool set holder 100 may be formed from a single piece of sheet metal. The tool set holder 100 may also be formed of separate metal pieces that are then combined to constitute the tool set holder 100.

In some embodiments, the tool set holder 100 includes a base 102. In some embodiments, the base 102 is a platform. In some embodiments, the base 102 is configured to receive a tool set insert containing one or more tools from a tool set. In some embodiments, the base 102 includes a first aperture 104 and a second aperture 106. The first aperture 104 and the second aperture 106 may be positioned on the base 102 such that a user’s hand may be inserted partially through either the first aperture 104 and/or the second aperture 106 to attach the tool set holder 100 to the vertical surface of the work center. Further, the first aperture 104 and the second aperture 106 may be spaced from a respective side edge of the base 102 by a predetermined amount, such as between 1 inch and 4 inches.

In some embodiments, the tool set holder 100 includes a bottom flange 108 extending forward from a bottom edge of the base 102. The bottom flange 108 may support the tool set insert when the tool set holder 100 is attached to the vertical surface of the work center. The bottom flange 108 may have a length that is greater than or equal to a thickness of the tool set insert that is supported by the tool set holder 100, such as between 0.5 inches and 6 inches. Further, in some embodiments, the length of the bottom flange 108 may be adjustable to support a variety of tool set inserts.

In some embodiments, the bottom flange 108 further includes a lower lip surface 110 that extends upwards from an outermost edge of the bottom flange 108. The lower lip surface 110 may further secure the tool set insert to the tool set holder 100. The lower lip surface 110 may have a length that is shorter than the length of the bottom flange 108, such as between 0.1 inches and 1 inch.

In some embodiments, the tool set holder 100 includes a first side flange 112 extending forward from a first side edge of the base 102 and a second side flange 116 extending forward from a second side edge of the base 102. The tool set holder 100 may receive the tool set insert between the first side flange 112 and the second side flange 116. Each of the first side flange 112 and the second side flange 116 may have a length that is greater than or equal to a thickness of the tool set insert that is supported by the tool set holder 100, such as between 0.5 inches and 6 inches. Further, in some embodiments, the length of each of the first side flange 112 and the second side flange 116 may be adjustable to support a variety of tool set holders. The first side flange 112 and the second side flange 116 may also be spaced apart a predetermined length, such as between 12 inches and 48 inches, corresponding to a length of the tool set insert such that the tool set insert may be received between them. The predetermined length may be selected to provide sufficient gripping force to support the tool set insert without impairing access to the tools in the tool set insert. Further, in some embodiments, the distance between the first side flange 112 and the second side flange 116 may be adjustable to support a variety of tool set inserts.

In some embodiments, the first side flange 112 further includes a first side fringe surface 114 that extends inwards from an outermost edge of the first side flange 112, and the second side flange 116 further includes a second side fringe surface 118 that extends inwards from an outermost edge of the second side flange 116. The first side fringe surface 114 and the second side fringe surface 118 may further secure the tool set insert to the tool set holder 100. Each of the first side fringe surface 114 and the second side fringe surface 118 may have a length that is shorter than the length of the first side flange 112 and the second side flange 116, respectively, such as between 0.1 inches and 1 inch.

In some embodiments, the tool set holder 100 also includes at least one posterior flange 120 extending rearward from the base 102. The posterior flange 120 is configured to attach the tool set holder 100 to the vertical surface of the work center. The posterior flange 120 may extend rearward from the base 102 at and/or near an exterior side of either the first aperture 104 and/or the second aperture 106.

In some embodiments, the tool set holder 100 is attached to the vertical surface of the work center via the posterior flange 120 such that the base 102 is substantially parallel to the vertical surface of the work center. For instance, the base 102 may be mounted to the vertical surface via the posterior flange 120 such that the base 102 is plus or minus five degrees from vertical. With this arrangement, the tool set insert containing the one or more tools from the tool set is resting on the bottom flange 108 of the tool set holder 100.

In other embodiments, the tool set holder 100 is attached to the vertical surface of the work center via the posterior flange 120 such that the base 102 is sloped away from the vertical surface of the work center. For instance, the base 102 may be mounted to the vertical surface via the posterior flange 120 such that the base 102 is between 15 and 75 degrees from vertical. With this arrangement, the tool set insert containing the one or more tools from the tool set is partially resting on the base 102 and partially resting on the bottom flange 108 of the tool set holder 100.

Further, in other embodiments, the tool set holder 100 is attached to the vertical surface of the work center via the posterior flange 120 such that the base 102 is substantially perpendicular to the vertical surface of the work center. For instance, the base 102 may be mounted to the vertical surface via the posterior flange 120 such that the base 102 is plus or minus five degrees from horizontal. With this arrangement, the tool set insert containing the one or more tools from the tool set is resting on the base 102 of the tool set holder 100.

In some embodiments, the posterior flange 120 is shaped such that the posterior flange 120 supports the tool set holder 100 in a predetermined position. Further, in some embodiments, the shape of the posterior flange 120 may be selected to balance competing needs of maintaining structural integrity with reducing size and weight of the tool set holder 100. The posterior flange 120 may have a thickness that is sufficient to support the tool set holder 100 with both the tool set insert and the tools inserted on the vertical surface of the work center.

As shown in FIGS. 1A and 1B, the posterior flange 120 of the tool set holder 100 includes a first posterior flange 122 and a second posterior flange 126. In the embodiment of the tool set holder 100 illustrated in FIGS. 1A and 1B, the first posterior flange 122 and the second posterior flange 126 directly connect the tool set holder 100 to the vertical surface of the work center.

In some embodiments, the first posterior flange 122 and the second posterior flange 126 directly connect the tool set holder 100 to the vertical surface of the work center via an integral element of each of the first posterior flange 122 and the second posterior flange 126. For instance, the first posterior flange 122 may further include a first set of hooks 124 that are configured to be received in a first series of slots or slits on the vertical surface of the work center and the second posterior flange 126 further includes a second set of hooks 128 that are configured to be received in a second series of slots on the vertical surface of the work center. Accordingly, a distance between the first posterior flange 122 and the second posterior flange 126 may be selected to correspond with slots that are prearranged on the vertical surface of the work center. As shown in FIGS. 1A and 1B, the first set of hooks 124 and the second set of hooks 128 each include two hooks, but in other embodiments the first set of hooks 124 and the second set of hooks 128 each include more or less than two hooks. A distance between respective hooks of the first set of hooks 124 and the second set of hooks 128 may also be selected to correspond with respective series of slots that are prearranged on the vertical surface of the work center. The tool set holder 100 is thus supported by the vertical surface of the work center via the first set of hooks 124 and the second set of hooks 126.

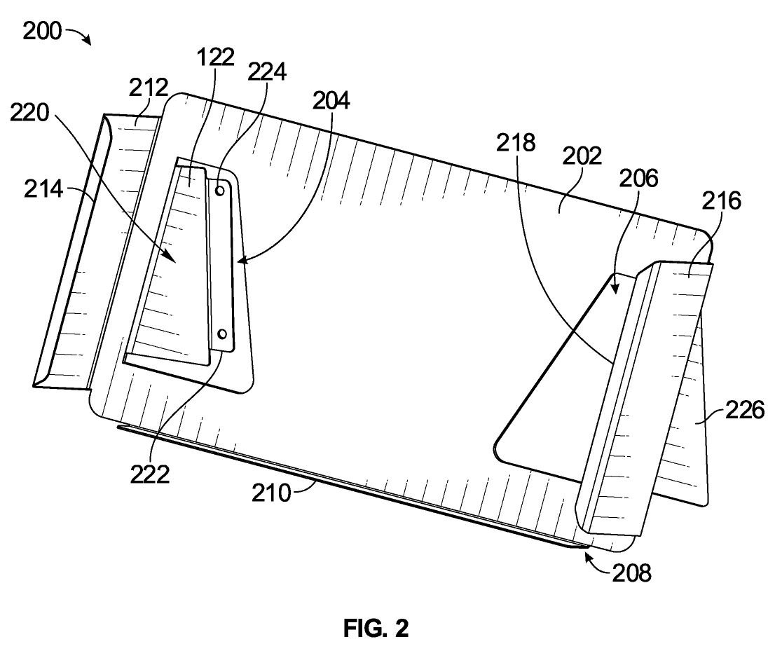

In some embodiments, a tool set holder 200 may include a posterior flange 220 configured to indirectly connect the tool set holder 200 to a vertical surface of a work center. FIG. 2 illustrates the tool set holder 200 including the posterior flange 200 being a first posterior flange 222 and a second posterior flange 226, according to an example embodiment. The tool set holder 200 is attachable to a vertical surface of a work center.

In the embodiment of the tool set holder 200 illustrated in FIG. 2, the first posterior flange 222 and the second posterior flange 226 indirectly connect the tool set holder 200 to the vertical surface of the work center. The first posterior flange 222 further includes a first set of holes 224 and the second posterior flange 226 further includes a second set of holes. The first set of holes 224 and the second set of holes each comprise two holes, but in other embodiments the first set of holes 224 and the second set of holds each include more or less than two holes. A fastener is configured to be inserted through each hole of the first set of holes 224 and the second set of holes. In some embodiments, the fastener may be a screw, a magnet, or another attachment device. The tool set holder 200 is thus supported by the vertical surface of the work center via the fastener inserted through the first set of holes 224 and the second set of holes.

The tool holder 200 may include any of the components as described above with respect to FIGS. 1A and 1B above. The tool set holder 200 may include a base 202 configured to receive a tool set insert containing one or more tools from a tool set. In some embodiments, the base 202 includes a first aperture 204 and a second aperture 206. In some embodiments, the tool set holder 200 includes a bottom flange 208 extending forward from a bottom edge of the base 202 and a lower lip surface 210 that extends upwards from an outermost edge of the bottom flange 208.

In some embodiments, the tool set holder 200 includes a first side flange 212 extending forward from a first side edge of the base 202 and a second side flange 216 extending forward from a second side edge of the base 202. The tool set holder 200 receives the tool set insert between the first side flange 212 and the second side flange 216. Further, in some embodiments, the first side flange 212 further includes a first side fringe surface 214 that extends inwards from an outermost edge of the first side flange 212 and the second side flange 216 further includes a second side fringe surface 218 that extends inwards from an outermost edge of the second side flange 216.

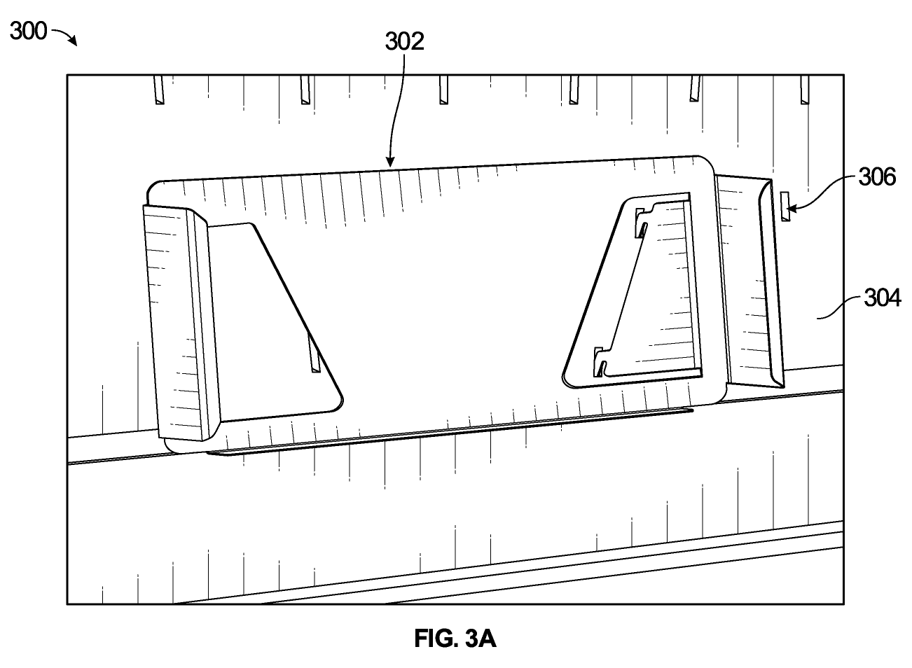

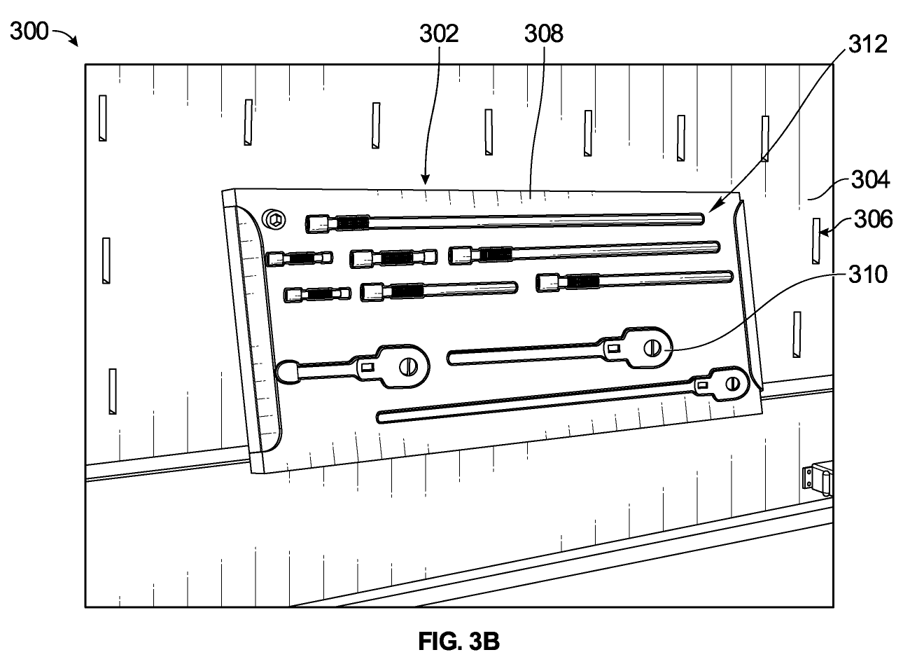

FIGS. 3A-3B illustrate a work center 300, according to an example embodiment. In some embodiments, the work center 300 is a work station or a work bench.

In some embodiments, the work center 300 includes a tool set holder 302. The tool set holder 302 may include any components described above with respect to FIGS. 1A, 1B, and FIG. 2. In some embodiments, the work center 300 includes a vertical surface 304 having a plurality of attachment points 306. The plurality of attachment points 306 shown in FIG. 3A are slots in the vertical surface 304, but in other embodiments attachment points may include magnetic connection points, notches, protrusions, and clips.

FIG. 3B shows the work center 300 with a tool set insert 308 containing one or more tools 310 from a tool set 312 inserted into the tool set holder 302. In some embodiments, the tool set insert 308 includes a piece of foam sized and shaped to receive the one or more tools 310 from the tool set. In some embodiments, the tool set insert 308 is a container or vessel that houses the one or more tools 310 from the tool set.

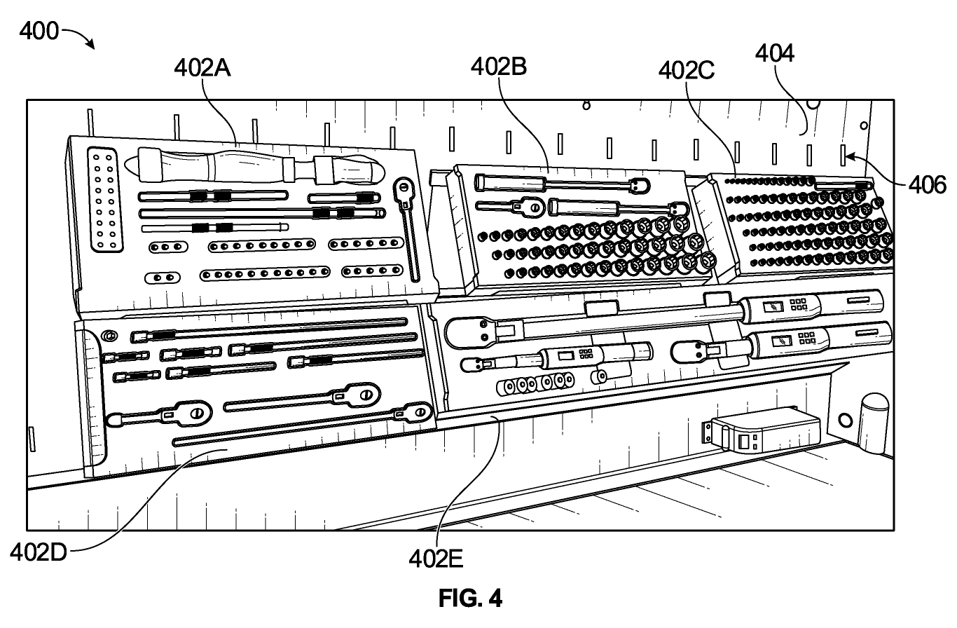

FIG. 4 illustrates a work center 400, according to an example embodiment. The work center 400 may be the same or similar form as the work center 300.

In some embodiments, the work center 400 includes a plurality tool set holders 402A, 402B, 402C, 402D, and 402E. The plurality of tool set holders 402A, 402B, 402C, 402D, and 402E may each include any components of the tool set holders 100, 200, and 302 described above with respect to FIGS. 1A to 3B. In some embodiments, the work center 400 further includes a vertical surface 404 having a plurality of attachment points 406.

In some embodiments, the work center 400 can include a plurality of tool set holders, such as the plurality of tool set holders 402A, 402B, 402C, 402D, and 402E shown in FIG. 4, such that all of the tools in a tool set are able to be displayed on the vertical surface 404 of the work center 400. With this arrangement, each tool set holder of the plurality of tool set holders can be sized or shaped to accommodate a particular portion of the one or more tools in the tool set. Further, in some embodiments, a shape of each of the plurality of tool set holders 402A, 402B, 402C, 402D, and 402E shown in FIG. 4 may be selected to hold a specific subsection of tools in the tool set. For instance, one tool set holder of the plurality of tool set holders 402A, 402B, 402C, 402D, and 402E may be configured to releasably to hold a plurality sockets and at least one socket ratchet wrench, a second tool set holder of the plurality of tool set holders 402A, 402B, 402C, 402D, and 402E may be configured to releasably to hold a plurality of socket extension bars.

The present disclosure describes various features and operations of the disclosed systems. The illustrative implementations described herein are not meant to be limiting. Certain aspects of the disclosed systems can be arranged and combined in a variety of different configurations, all of which are contemplated herein.

Further, unless context suggests otherwise, the features illustrated in each of the figures may be used separately or in combination. Thus, the figures should be generally viewed as component aspects of one or more overall implementations, with the understanding that not all illustrated features are necessary for each implementation.

While various aspects and embodiments are described herein, other aspects and embodiments will be apparent to those skilled in the art. The various aspects and embodiments disclosed herein are for purposes of illustration and are not intended to be limiting, with the true scope being indicated by the claims, along with the full scope of equivalents to which such claims are entitled. It is also to be understood that the terminology used herein for the purpose of describing embodiments only, and is not intended to be limiting.

In this description, the articles “a,” “an,” and “the” are used to introduce elements and/or functions of the example embodiments. The intent of using those articles is that there is one or more of the introduced elements and/or functions.

In this description, the intent of using the term “and/or” within a list of at least two elements or functions and the intent of using the terms “at least one of,” "at least one of the following,” “one or more of,” “one or more from among,” and “one or more of the following” immediately preceding a list of at least two components or functions is to cover each embodiment including a listed component or function independently and each embodiment including a combination of the listed components or functions.

The use of ordinal numbers such as “first,” “second,” “third” and so on is to distinguish respective elements rather than to denote an order of those elements unless the context of using those terms explicitly indicates otherwise. Further, the description of a “first” element, such as a first plate, does not necessitate the presence of a second or any other element, such as a second plate.

Implementations of the present disclosure can thus relate to one of the enumerated examples (EE) listed below.

EE 1 is a tool set holder including a base configured to receive a tool set insert containing one or more tools from a tool set, a bottom flange extending forward from a bottom edge of the base configured to support the tool set insert, and a first side flange extending forward from a first side edge of the base and a second side flange extending forward from a second side edge of the base. The tool set insert is configured to be received in the tool set holder between the first side flange and the second side flange. The tool set holder also includes a posterior flange extending rearward from the base. The posterior flange is configured to attach the tool set holder to a vertical surface of a work center.

EE 2 is the tool set holder of EE 1, the base including a first aperture and a second aperture such that a hand of a user of the tool set holder may be inserted partially through the first aperture or the second aperture.

EE 3 is the tool set holder of EE 2, the first aperture being spaced from the first side edge by a predetermined amount and the second aperture being spaced from the second side edge by the predetermined amount.

EE 4 is a tool set holder of any of EE 1 to EE 3, the one or more tools being a full tool set.

EE 5 is the tool set holder of any of EE 1 to EE 4, the bottom flange having a length that is greater than or equal to a thickness of the tool set insert.

EE 6 is the tool set holder of any of EE 1 to EE 5, the bottom flange being adjustable.

EE 7 is the tool set holder of any of EE 1 to EE 6, the bottom flange further having a lower lip surface that extends upwards from an outermost edge of the bottom flange.

EE 8 is the tool set holder of any of EE 1 to EE 7, the first side flange having a length that is greater than or equal to a thickness of the tool set insert and the second side flange having a length that is greater than or equal to the thickness of the tool set insert.

EE 9 is a tool set holder of any of EE 1 to EE 8, the first side flange and the second side flange being spaced apart a predetermined length, and the predetermined length corresponding with a length of the tool set insert.

EE 10 is a tool set holder of any of EE 1 to EE 9, a distance between the first side flange and the second side flange being adjustable.

EE 11 is the tool set holder of any of EE 1 to EE 10, the first side flange further having a first side fringe surface that extends inwards from an outermost edge of the first side flange and the second side flange further having a second side fringe surface that extends inwards from an outermost edge of the second side flange.

EE 12 is the tool set holder of any of EE 1 to EE 11, the base and the posterior flange being integrally-formed.

EE 13 is the tool set holder of any of EE 1 to EE 12, the base and the posterior flange being formed separately and subsequently coupled together.

EE 14 is the tool set holder of any of EE 1 to EE 13, the posterior flange further having a hook configured to be received in a slot of the vertical surface of the work center.

EE 15 is the tool set holder of any of EE 1 to EE 14, the posterior flange further having a hole such that a fastener is configured to connect the tool set holder to the vertical surface through the hole.

EE 16 is a work center having a vertical surface with a plurality of attachment points and a tool set holder. The tool set holder includes a base configured to receive a tool set insert containing one or more tools from a tool set, a bottom flange extending forward from a bottom edge of the base configured to support the tool set insert, and a first side flange extending forward from a first side edge of the base and a second side flange extending forward from a second side edge of the base. The tool set insert is configured to be received in the tool set holder between the first side flange and the second side flange. The tool set holder also includes a posterior flange extending rearward from the base. The posterior flange is configured to attach the tool set holder to the vertical surface of the work center.

EE 17 is the work center of EE 16, the plurality of attachment points each having a slot in the vertical surface, and the posterior flange further including a hook configured to be received in the slot of the vertical surface of the work center.

EE 18 is the work center of any of EE 16 to EE 17, the posterior flange further having a hole such that a fastener is configured to connect the tool set holder to the vertical surface through the hole at an attachment point of the plurality of attachment points.

EE 19 is the work center of any of EE 16 to EE 18, further being a plurality of tool set holders, each of the plurality of tool set holders having a base configured to receive a tool set insert containing one or more tools from a tool set, a bottom flange extending forward from a bottom edge of the base configured to support the tool set insert, and a first side flange extending forward from a first side edge of the base and a second side flange extending forward from a second side edge of the base. The tool set insert is configured to be received in the tool set holder between the first side flange and the second side flange. The tool set holder also including a posterior flange extending rearward from the base. The posterior flange is configured to attach the tool set holder to the vertical surface of the work center.

EE 20 is the work center of EE 19, each tool set holder of the plurality of tool set holders including dimensionality configured to accommodate a particular portion of the one or more tools in the tool set.

What is claimed is:

1. A tool set holder comprising:
a base configured to receive a tool set insert containing one or more tools from a tool set;
a bottom flange extending forward from a bottom edge of the base, wherein the bottom flange is configured to support the tool set insert;
a first side flange extending forward from a first side edge of the base and a second side flange extending forward from a second side edge of the base, wherein the tool set insert is configured to be received in the tool set holder between the first side flange and the second side flange; and
a posterior flange extending rearward from the base, wherein the posterior flange is configured to attach the tool set holder to a vertical surface of a work center.

2. The tool set holder of claim 1, wherein the base includes a first aperture and a second aperture such that a hand of a user of the tool set holder may be inserted partially through the first aperture or the second aperture.

3. The tool set holder of claim 2, wherein the first aperture is spaced from the first side edge by a predetermined amount, and wherein the second aperture is spaced from the second side edge by the predetermined amount.

4. The tool set holder of claim 1, wherein the one or more tools comprises a full tool set.

5. The tool set holder of claim 1, wherein the bottom flange comprises a length that is greater than or equal to a thickness of the tool set insert.

6. The tool set holder of claim 1, wherein the bottom flange is adjustable.

7. The tool set holder of claim 1, wherein the bottom flange further comprises a lower lip surface that extends upwards from an outermost edge of the bottom flange.

8. The tool set holder of claim 1, wherein the first side flange comprises a length that is greater than or equal to a thickness of the tool set insert, and wherein the second side flange comprises a length that is greater than or equal to the thickness of the tool set insert.

9. The tool set holder of claim 1, wherein the first side flange and the second side flange are spaced apart a predetermined length, and wherein the predetermined length corresponds with a length of the tool set insert.

10. The tool set holder of claim 1, wherein a distance between the first side flange and the second side flange is adjustable.

11. The tool set holder of claim 1, wherein the first side flange further comprises a first side fringe surface that extends inwards from an outermost edge of the first side flange, and wherein the second side flange further comprises a second side fringe surface that extends inwards from an outermost edge of the second side flange.

12. The tool set holder of claim 1, wherein the base and the posterior flange are integrally-formed.

13. The tool set holder of claim 1, wherein the base and the posterior flange are formed separately and subsequently coupled together.

14. The tool set holder of claim 1, wherein the posterior flange further comprises a hook, and wherein the hook is configured to be received in a slot of the vertical surface of the work center.

15. The tool set holder of claim 1, wherein the posterior flange further comprises a hole such that a fastener is configured to connect the tool set holder to the vertical surface through the hole.

16. A work center comprising:
a vertical surface having a plurality of attachment points; and
a tool set holder comprising:
a base configured to receive a tool set insert containing one or more tools from a tool set;
a bottom flange extending forward from a bottom edge of the base, wherein the bottom flange is configured to support the tool set insert;
a first side flange extending forward from a first side edge of the base and a second side flange extending forward from a second side edge of the base, wherein the tool set insert is configured to be received in the tool set holder between the first side flange and the second side flange; and
a posterior flange extending rearward from the base, wherein the posterior flange is configured to attach the tool set holder to the vertical surface of the work center.

17. The work center of claim 16, wherein the plurality of attachment points each comprise a slot in the vertical surface, and wherein the posterior flange further comprises a hook configured to be received in the slot of the vertical surface of the work center.

18. The work center of claim 16, wherein the posterior flange further comprises a hole such that a fastener is configured to connect the tool set holder to the vertical surface through the hole at an attachment point of the plurality of attachment points.

19. The work center of claim 16, further comprising:
a plurality of tool set holders, each of the plurality of tool set holders comprising:
a base configured to receive a tool set insert containing one or more tools from a tool set;
a bottom flange extending forward from a bottom edge of the base, wherein the bottom flange is configured to support the tool set insert;
a first side flange extending forward from a first side edge of the base and a second side flange extending forward from a second side edge of the base, wherein the tool set insert is configured to be received in the tool set holder between the first side flange and the second side flange; and
a posterior flange extending rearward from the base, wherein the posterior flange is configured to attach the tool set holder to the vertical surface of the work center.

20. The work center of claim 19, each tool set holder of the plurality of tool set holders comprises dimensionality configured to accommodate a particular portion of the one or more tools in the tool set.
